(19) United States
(12) Patent Application Publication
(10) Pub. No.: US 2002/0069221 A1
(43) Pub. Date: Jun. 6, 2002

(54) METHOD AND SYSTEM FOR REPRESENTING A TABLE WITH MULTIPLE FOCAL LEVELS

(76) Inventors: RAMANA B. RAO, SAN FRANCISCO, CA (US); TICHOMIR G. TENEV, SAN JOSE, CA (US)

Correspondence Address: HAYNES BEFFEL & WOLFELD LLP, P O BOX 366, HALF MOON BAY, CA, 94019, US

(21) Appl. No.: 09/203,481

(22) Filed: Dec. 2, 1998

Related U.S. Application Data
(60) Provisional application No. 60/067,242, filed on Dec. 2, 1997.

(51) Int. Cl. G06F 15/00

(52) U.S. Cl. 707/509

(57) ABSTRACT

A multi-level focus software visualization tool uses a focus+context visualization technique for displaying tables in which multiple table cells may be mapped to a single pixel or a single pixel row. Three or more focus levels may be used instead of the conventional two-focus levels. Accordingly, the whole table presented can be seen on the screen, thus minimizing the mechanical overhead of user navigation and allowing the user to quickly spot trends and outlining data.

### RELATED APPLICATIONS

Applicants claim the benefit of U.S. Provisional Application No. 60/067,242, filed on Dec. 2, 1997. This application is related to application Ser. No. ______, filed on Dec. 2, 1998, entitled “Interactive Interface for Visualizing and Manipulating Multi-Dimensional Data,” by Ramana Rao, Tichomir Tenev, and Stuart Card.

### FIELD OF THE INVENTION

The present invention relates generally to the field of data access and interaction, and more particularly to the analysis and visualization of data sets.

### DESCRIPTION OF THE RELATED ART

Computers excel in their ability to store and process information. The spreadsheet is a common software tool for processing and presenting data and relationships between particular items in the data. Spreadsheets can be used to view tables that represent multivariate data sets (i.e., data sets having two dimensions, one dimension of variables and a second dimension of cases associated with the variables), in which the variables of the multivariate data set are arranged in the columns of the table and the cases associated with the variables are arranged in the rows of the table.

Table I illustrates a conventional table showing the relationship between various baseball players and their statistics. The variables in Table I are “At Bats,” “Hits,” “Home Runs,” and “Stolen Bases.” The cases, or instances of the variables are each of the players “John,” “Bill,” and “Lois.”

TABLE I

| Player | At Bats | Hits | Home Runs | Stolen Bases |
|---|---|---|---|---|
| John | 50 | 10 | 2 | 3 |
| Bill | 48 | 12 | 0 | 1 |
| Lois | 53 | 15 | 4 | 0 |

Tables, such as Table I, are useful tools for manipulating and analyzing data. One disadvantage associated with conventional tables, however, is that as the size of the data set increases, the user will not be able to view the whole data set on the computer display. Additionally, conventional tables are generally displayed using textual (usually numeric) representations of their values. Although textual representation of numeric values give the user the precise value of the variable, humans are not able to quickly process large arrays of textual values for underlying patterns, relationships, or extreme values.

U.S. Pat. No. 5,632,009 to Rao et al., which is hereby incorporated by reference, describes a tool that improves upon the traditional table representation of data. The tool allows users to view multivariate data sets using a mixed graphical/textual representation of the data. This “focus+context” technique allows for visualization and manipulation of large two-dimensional tables (roughly 30-100 times as big in the same screen space as a conventional spreadsheet or table browser). Because the focus+context technique displays much more of the table at once by using graphics to show values, a user can examine patterns in the whole table as well as zoom in on specific content without losing global context.

FIG. 1 is a diagram of a table represented with the focus+context technique. Row identifier regions 14 correspond to the cases (names) of Table I, column identifier regions 18 correspond to the variables of Table I. Certain of the variable values in table 100, unlike those in Table I, however, are represented graphically. Graphical regions 25 are context regions and textual regions 23 are focus regions. Because context regions 25 are represented graphically, data rows may be as few as one pixel high, thereby allowing significantly more data to be represented on the computer screen than a completely textual representation. Focus values 23, on the other hand, are represented textually, allowing the user to read the value exactly.

By using two levels of space assignment to data rows, focus area 23 and context area 25, table 100 significantly increases the viewable portion compared to a conventional table. Other advantages of the focus+context technique include:

(1) Ease of navigation: An entire data set, or at least a large portion of the data set, can fit on the screen at once, thus minimizing the mechanical overhead of navigation.

(2) Ease of exploration: Graphical representation of data allows the user to quickly spot trends and outlining data.

Although the focus+context technique is a powerful tool for viewing and manipulating multivariate data, it runs into limitations when the table becomes too large. For example, tables greater than approximately 500 cases (rows) by 40 variables (columns) cannot fully be shown on most computer displays using focus+context. In this situation, scroll bars may be used to allow the user to navigate through the table. Even with scroll bars, however, the exploratory and navigational ease and power of the graphical nature of the focus+context technique is degraded.

There is, therefore, a need in the art to improve the traditional focus+context techniques for large data sets.

### SUMMARY OF THE INVENTION

Objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

To achieve the objects and in accordance with the purpose of the invention, as embodied and broadly described herein, a first aspect consistent with the present invention is a method of displaying a data set organized as a table of cells. The method comprises a plurality of steps, including the steps of designating a first range of cells in the table as belonging to a primary focal region; designating a second range of cells in the table as belonging to a secondary focal region; and designating the cells in the table not within the first or second range of cells as belonging to a background focal region. The designated cells are then displayed. The displaying steps include displaying the cells in the primary focal region using a first representation of cell value; displaying the cells in the secondary focal region using a second representation of cell value in which each cell value is represented graphically and in which each cell corresponds to a single graphical unit; and displaying the cells in the background focal region using a third representation of cell value in which a plurality of cell values are represented with a single graphical unit.

A second aspect consistent with the present invention is a method of displaying a data set organized as a table of cells. The method comprises a plurality of steps, including the steps of designating a range of cells in the table as belonging to a primary focal region; and designating cells not belonging to the primary focal region as belonging to one of a plurality of focal spans. The designated cells are then displayed. The displaying steps include displaying the cells in the primary focal region using a first representation of cell value and displaying each focal span using a graphical representation of cell value in which the display space allotted to each cell in each span is based on the total size of the span.

Other aspects of the present invention, related to the method of displaying a data set organized as a table of cells, are directed to computer systems.

### BRIEF DESCRIPTION OF DRAWINGS

The accompanying drawings, which are incorporated in and constitute a part of this specification, illustrate several embodiments consistent with this invention and, together with the description, help explain the principles of the invention. In the drawings,

FIG. 1 is a diagram of a table represented with a focus+context technique;

FIG. 2 is a block diagram of an exemplary computer system;

FIG. 3 is a diagram of an exemplary two-level mapping function;

FIG. 4 is a diagram of an exemplary three-level mapping function;

FIG. 5 is an illustration of a table using a tri-level focus visualization scheme consistent with a first aspect of the present invention;

FIG. 6 is a flow chart illustrating methods consistent with the present invention for determining the location of primary, secondary, and background focal levels; and

FIGS. 7 and 8 are illustrations of tables using a tri-level focus visualization scheme consistent with a second aspect of the present invention.

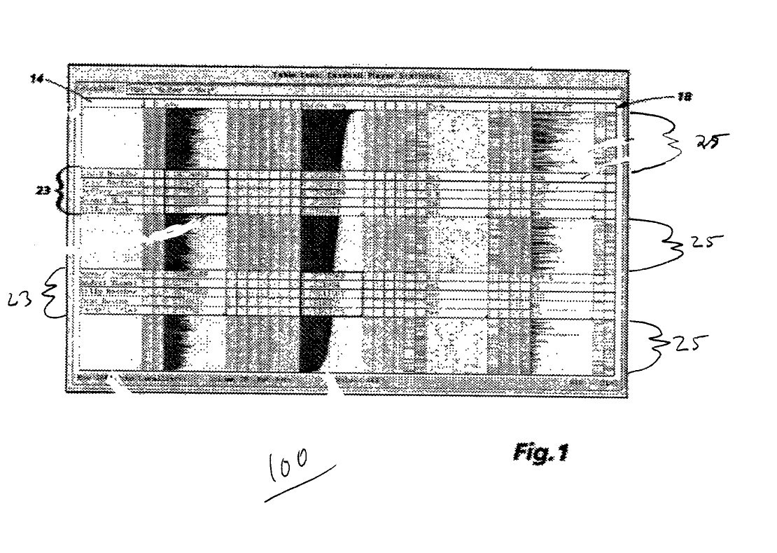

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

A multi-level focus software visualization tool consistent with the present invention uses a focus+context visualization technique for displaying tables in which multiple table cells may be mapped to a single pixel or a single pixel row. Additionally, three or more focus levels may be used instead of the conventional two-focus levels.

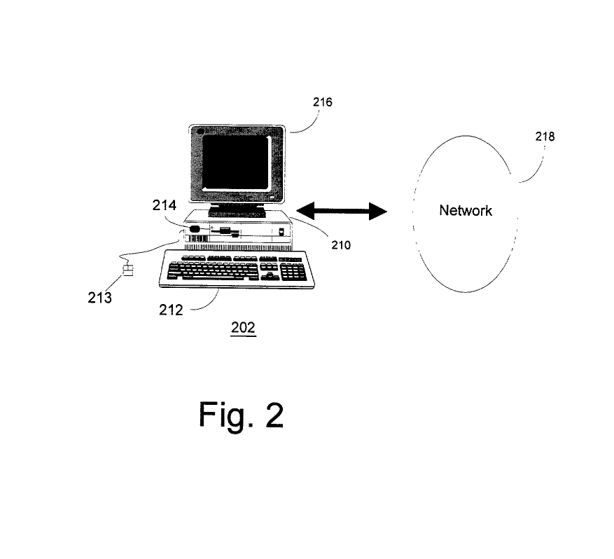

FIG. 2 is a block diagram of an exemplary computer system that may be used to implement the software visualization tool. Computer system 202 includes a chassis 210, which holds the computer's main processor and main memory (in which the software tool may be stored); input devices such as keyboard 212, and a pointing device such as a mouse 213; a secondary storage device such as floppy or hard disk drive 214; and a display such as monitor 216. Computer system 202 is optionally connected to a network 218, and may be operated directly by a user or through network 218.

Many variations of computer system 202 are possible. For example storage device 214 may additionally include storage media such as optical disks, and mouse 213, may additionally or alternatively include other pointing devices such as a trackball, a lightpen, a touch-sensitive pad, a digitizing tablet, or a joystick.

Computer 202 internally represents the cells of a table as the full numerical value of the cell. When displaying the table graphically, a mapping function is used to map from the internal representation of the table (often called the abstract table representation) to the table image representation displayed on monitor 216.

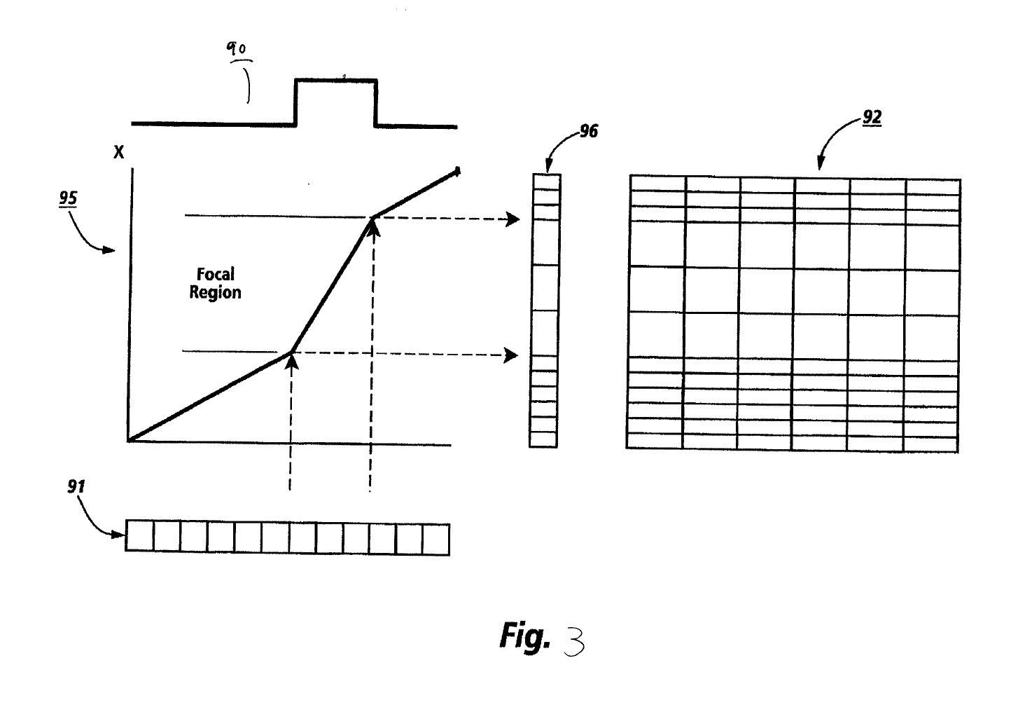

FIG. 3 is a diagram of an exemplary two-level mapping function. Table image 92 has twelve rows, represented by region array 91. Mapping function 90 determines which rows of table image 92 are in the focus and which rows are outside the focus. Those inside the focus are displayed as being vertically longer than those outside the focus. The result of the mapping can be seen in single column 96. Table image 92 shows propagation of the allocated cell region sizes in column 96 across all columns in table image 92.

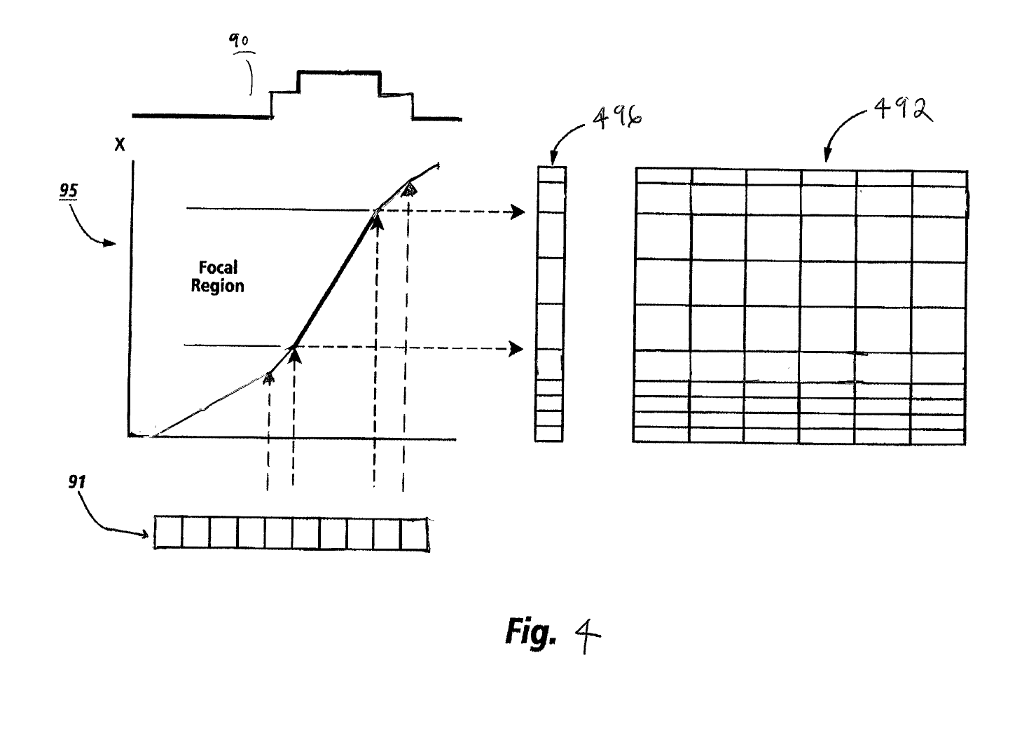

Although mapping function 90 is shown as a two-level mapping function, consistent with the present invention, mapping function 90 may be extended to three or more levels. FIG. 4 illustrates an exemplary three-level mapping function. The regions shown in FIG. 4 are similar to those shown in FIG. 3, except three distinct regions are created in table image 492 and column 496.

A separate mapping function may be used for each of the two dimensions in the visual model. As long as separate one-dimensional mapping functions are used for each dimension, the tabular arrangement of the grid elements in the visual table preserves the user's ability to interpret relationships. Thus, all cells of a row in the abstract table model will visually appear in the same row on display 216.

The mapping functions used for a particular table are not constant. Rather, the user is given the ability to modify the mapping function by selecting and manipulating areas of the table image.

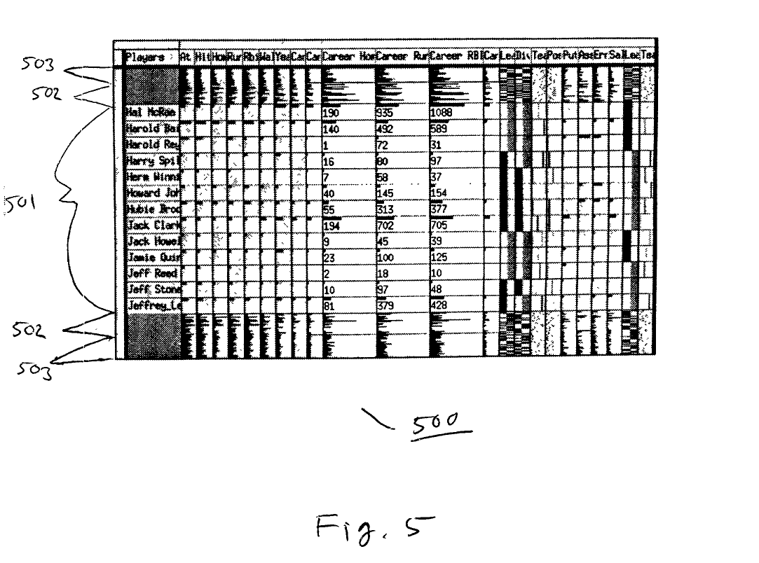

FIG. 5 is an illustration of a table image 500 using a tri-level focus visualization scheme consistent with a first embodiment of the present invention. The space used on display 216 for each cell of table 500 is directly dependent on the focal level of the cell. A three-level mapping function is used along the vertical (column) axis, including: (1) primary focal area 501; (2) secondary focal areas 502; and (3) background focal area 503. So, for example, all cells in the primary focal area 501 are of the same height (e.g., 21 pixels) and all cells in the secondary focal area 502 are of the same height (e.g., 5 pixels). Similarly, an equal number of cells in background focal area 503 are allotted to one pixel or to one pixel row (i.e., allotted to one graphical unit).

In general, the user controls the location of primary focus 501 in table image 500, which is then automatically nested within areas of secondary focus and background focus. In this way, secondary focal areas 502 function as a context for primary focal area 501.

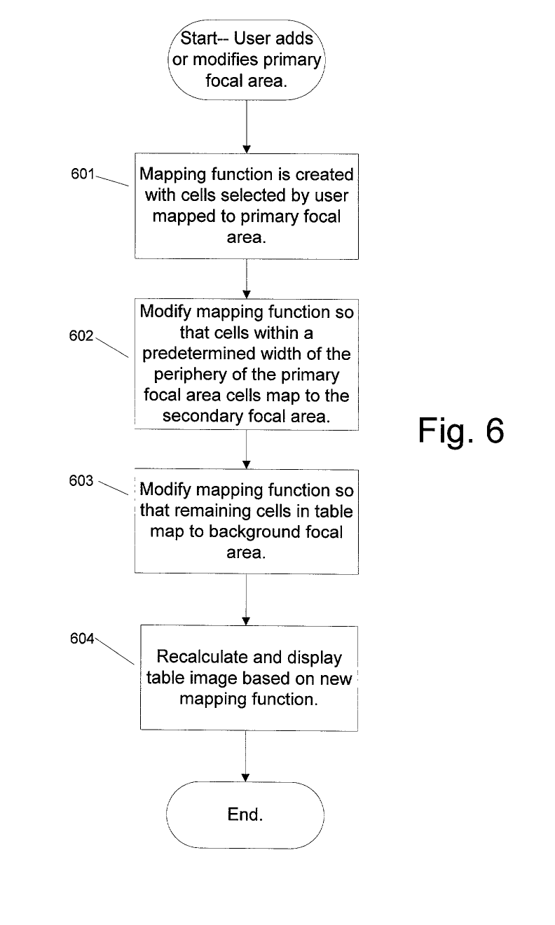

FIG. 6 is a flow chart illustrating in more detail methods consistent with the present invention for determining the location of the primary, secondary, and background focal levels. Cells selected by the user as being in the focus map to the primary focal area (step 601). Cells within a predetermined width of the periphery of the primary focal cells map to the secondary focal area (step 602). Any remaining cells are mapped to the background focal area (step 603). Finally, the table image is recalculated and displayed based on the new mapping function (step 604).

As previously mentioned, in the background focal area, multiple cells are mapped to a single pixel, or a single row of pixels. In practice, this means some form of aggregation operation is performed on the values of the cells mapped to a row. For example, the average value or the median value of the cells may be used as an aggregation operation.

The tri-level focus technique described above allocates space for each cell in the visual representation based on the focus level of that cell. An alternate multi-level focus technique consistent with the present invention, described below, allows the user to enter a size parameter that affects the visual size of a cell in the image table.

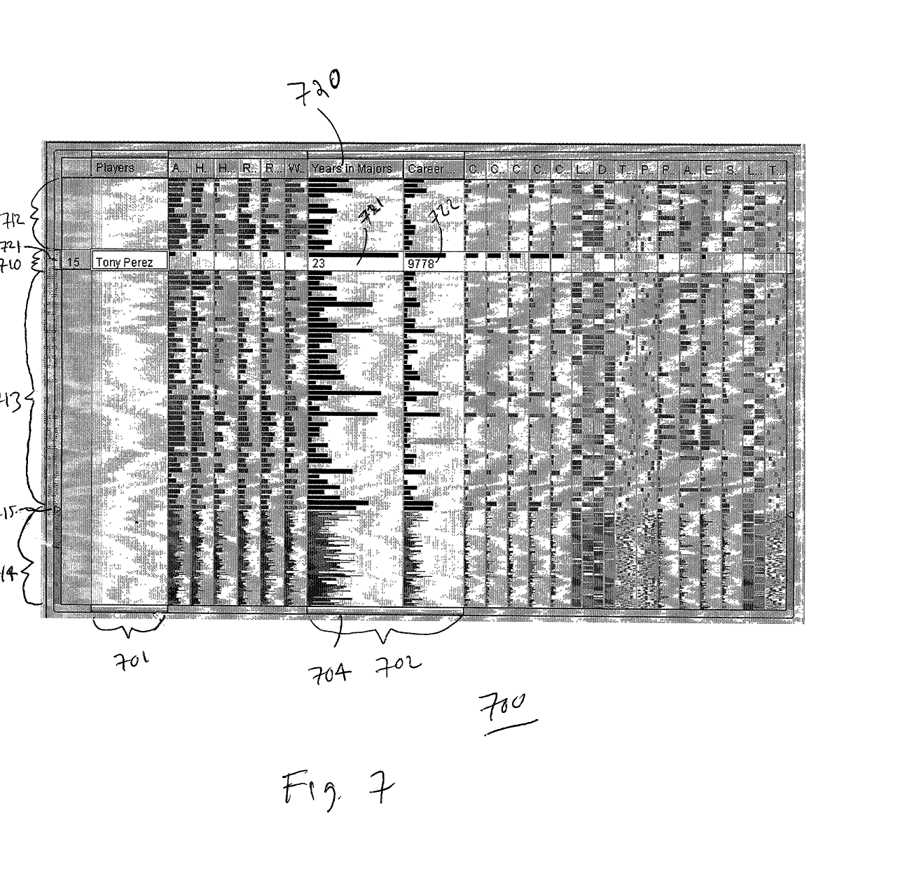

FIG. 7 is an illustration of a table image 700 using a multi-level focus visualization scheme that allows the user to control the size of the table image cells. Additionally, table image 700 uses a horizontal mapping function as well as a vertical one. Two primary row focal areas, labeled as areas 701 and 702 are included in table image 700. The size of column primary focal areas 701 and 702 can be controlled with a pointing device by moving the edges of column headers, such as header 720. Focal area 710 is surrounded by context areas 712, 713, and 714. Context areas 712, 713, and 714 are also called focal “spans.” The user may change the size of the spans by moving, with a pointing device, tick mark 715. Computer 100 then recalculates and redisplays the cell size of the cells in the modified spans based on the new total size of the span and the number of cells in the span. For example, if the user doubles the size of the span, each cell in the span would be allotted twice as much space on the display.

In addition to changing the size of a column, such as column 720, the user can move the primary focal areas and add or delete cells from the primary focal areas. For example, to move the primary focal area to the right of cells 721 and 722, the user moves bar rail 704 to the right. To move the primary focal areas up or down in the table, the user moves bar rail 721. To add or delete cells from the primary focus, the user clicks on a cell within a primary focal area, causing the software tool to present “grab handles” at the corners of the focal area, allowing the user to expand or contract the size of the primary focus by moving the grab handles.

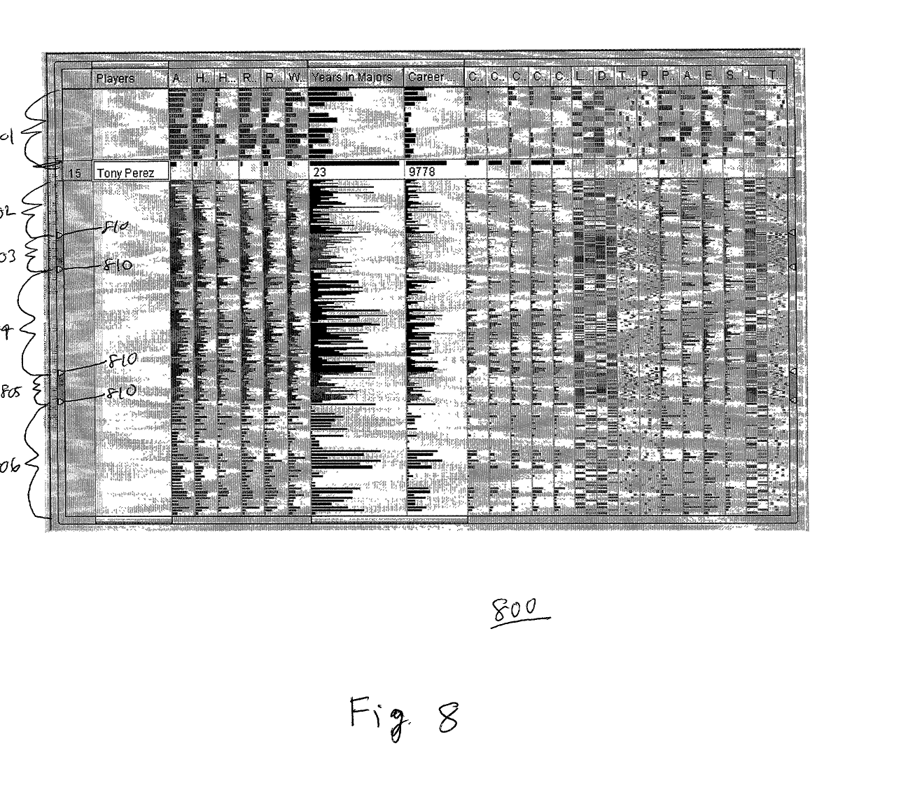

Multiple spans may be added by the user and the size of each individually adjusted. FIG. 8 is an illustration of table image 800, which similar to table image 700, but in which additional spans have been added by the user.

As shown in table 800, six spans are present on the vertical axis, labeled as spans 801, 802, 803, 804, 805, and 806. The user may alter the size of the spans, and hence the display area allotted to each cell in a span, by moving tick marks 810.

It will be apparent to those skilled in the art that various modifications and variations can be made to the present invention without departing from the scope or spirit of the invention. For example, although the concepts of the present invention were described as being applied to a two-dimensional data set, they could also be applied to a visualization scheme based on a multidimensional data set.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed:

1. A method of displaying a data set organized as a table of cells, the method comprising the steps of:
designating a first range of cells in the table as belonging to a primary focal region;
designating a second range of cells in the table as belonging to a secondary focal region;
designating the cells in the table not within the first or second range of cells as belonging to a background focal region;
displaying the cells in the primary focal region using a first representation of cell value;
displaying the cells in the secondary focal region using a second representation of cell value in which each cell value corresponds to a single graphical unit; and
displaying the cells in the background focal region using a third representation of cell value in which a plurality of cell values are represented with a single graphical unit.

2. The method of claim 1, wherein the first representation includes a textual representation of cell value.

3. The method of claim 1, wherein the steps of designating the first range of cells, designating the second range of cells, and designating the cells in the table not withing the first or second range of cells further includes the step of:
applying a mapping function that classifies the cells as being in one of the first range, second range, or not within the first or second range of cells.

4. The method of claim 1, wherein the step of designating the first range of cells further includes the step of:
designating cells selected by a user as being in the primary focal region.

5. The method of claim 1, wherein the step of designating the second range of cells further includes the step of:
designating the cells that surround the primary focal region as being in the secondary focal region.

6. A method of displaying a data set organized as a table of cells, the method comprising the steps of:
designating a range of cells in the table as belonging to a primary focal region;
designating cells not belonging to the primary focal region as belonging to one of a plurality of focal spans;
displaying the cells in the primary focal region using a first representation of cell value;
displaying each focal span using a graphical representation of cell value in which the display space allotted to each cell in each span is based on the total size of the span.

7. The method of claim 6, further including the step of
varying the size of the spans according to user input.

8. The method of claim 6, wherein the first representation of cell value includes a textual representation of cell value.

9. The method of claim 6, wherein the steps of designating the range of cells in the table as belonging to a primary focal region and designating cells not belonging to the primary focal region further includes the step of:
applying a mapping function that classifies the cells as being in one of the primary focal region or one of the plurality of focal spans.

10. A computer system comprising:
a processor;
a display coupled to the processor;
a memory coupled to the processor, the memory including computer instructions and computer data, the computer data including a data set organized as a table of cells, the computer instructions when executed on the processor causing the processor to perform the functions of
designating a first range of cells in the table as belonging to a primary focal region;
designating a second range of cells in the table as belonging to a secondary focal region;
designating the cells in the table not within the first or second range of cells as belonging to a background focal region;
displaying the cells in the primary focal region using a first representation of cell value;
displaying the cells in the secondary focal region using a second representation of cell value in which each cell value corresponds to a single graphical unit; and
displaying the cells in the background focal region using a third representation of cell value in which a plurality of cell values are represented with a single graphical unit.

11. The system of claim 10, wherein the processor further performs the function of:
applying a mapping function that classifies the cells as being in one of the first range, second range, or not within the first or second range of cells.

12. The system of claim 10, wherein the processor, when performing the function of designating the first range of cells, further performs the function of:
designating cells selected by a user as being in the primary focal region.

13. The method of claim 10, wherein the processor, when performing the function of designating the second range of cells, further performs the function of:
designating the cells that surround the primary focal region as being in the secondary focal region.

14. A computer system comprising:
a processor;
a display coupled to the processor;
a memory coupled to the processor, the memory including computer instructions and computer data, the computer data including a data set organized as a table of cells, the computer instructions when executed on the processor causing the processor to perform the functions of
designating a range of cells in the table as belonging to a primary focal region;
designating cells not belonging to the primary focal region as belonging to one of a plurality of focal spans;
displaying the cells in the primary focal region using a first representation of cell value;
displaying each focal span using a graphical representation of cell value in which the display space allotted to each cell in each span is based on the total size of the span.

15. The system of claim 14, wherein the processor further performs the function of:
varying the size of the spans according to user input.

16. The system of claim 14, wherein the first representation of cell value includes a textual representation of cell value.

17. The system of claim 14, wherein the functions of designating the range of cells in the table as belonging to a primary focal region and designating cells not belonging to the primary focal region further includes the function of:
applying a mapping function that classifies the cells as being in one of the primary focal region or one of the plurality of focal spans.
